(19) United States
(12) Patent Application Publication
(10) Pub. No.: US 2011/0184946 A1
(43) Pub. Date: Jul. 28, 2011

(54) APPLYING SYNONYMS TO UNIFY TEXT SEARCH WITH FACETED BROWSING CLASSIFICATION

(75) Inventors: Erik F. Hennum, San Francisco, CA (US); Marie L. Setnes, Rochester, MN (US); John S. Warren, Durham, NC (US)

(73) Assignee: International Business Machines Corporation, Armonk, NY (US)

(21) Appl. No.: 12/695,716

(22) Filed: Jan. 28, 2010

(51) Int. Cl. G06F 17/30

(52) U.S. Cl. 707/728; 707/E17.008; 707/E17.082; 707/769

(57) ABSTRACT

The invention provides a method and system for returning search results based on text and associated synonyms. The system including an input module configured for receiving a text search term. A search module is configured for searching index documents with the text search term to return matched index documents, and for searching synonym index entries to return classifications for synonym expansion for expanding the search for index documents. An analyzer module is configured for obtaining tokens for the text search term from the synonym index entries for determining matched synonym index entries. The search module is further configured for obtaining assigned synonym matching strength information of the matched synonym index entries in a search results list, and for sorting the search results list based on a confidence score to form a sorted search results list. An output module for presenting the sorted search result list on an interface module.

### BACKGROUND OF THE INVENTION

1. Field of the Invention

The present invention relates generally to search retrieval, and in particular to performing a search based on input text and associated synonyms.

2. Background Information

Current structured searching for content, such as an Internet search, is based on input text that is typically in the form of one or more words. The result of a typical search is usually a weighted index of text results, which can be based on many factors. Some of these factors include: weight based on a fee, weight based on probability of correctness, weight based on location, etc. A problem with text searching may arise when a searcher is not familiar with an exact search term. This can result in spending much time wading through search results that are not relevant to what the searcher intended to find.

### BRIEF SUMMARY OF THE INVENTION

One embodiment of the invention provides a method and system for providing faceted browsing with free form text query interpretation based on text and associated synonyms. One implementation comprises an input module configured for receiving one or more text search terms. A search module is configured for searching index documents with the text search terms to return matched index documents, and for searching a plurality of synonym index entries to return classifications for synonym expansion for expanding the search for index documents. An analyzer module is configured for obtaining tokens for the text search term from the synonym index entries for determining one or more matched synonym index entries. The search module is further configured for obtaining assigned synonym matching strength information of the matched synonym index entries in a search results list, and sorting the search results list based on a confidence score from the index documents and the assigned synonym matching strength of the index documents from the synonym expansion to form a sorted search results list. An output module for presenting the sorted search result list on an interface module.

In another embodiment of the invention, a system comprising a server device is coupled to a first repository including a plurality of index documents. A second repository includes a plurality of synonym index entries. An analyzer module is configured to analyze received text into a list of tokens representing the received text and associated synonyms. A search module is configured for searching the plurality of synonym index entries to find synonym index entries associated within a determined range of tokens. The search module further obtains tokens for each found synonym index entry. The obtained tokens are aggregated in a list of tokens. The list of found index documents is expanded using the synonym index entries. A search results list is sorted based on the confidence score from the index documents and the assigned synonym strength obtained from the found synonym index entries. The sorted search results list is provided as output.

In yet another embodiment of the invention, a method comprises providing a plurality of index documents and a plurality of related synonym index entries. A text search term is received from an interface device to search portions of the plurality of index documents and the plurality of synonym index entries. The plurality of index documents is searched to return index documents matching the text search term. The text search term is analyzed for one or more sorted lists of tokens representing the text search term and associated classified synonyms. The plurality of synonym index entries are searched to find synonym index entries associated with the sorted lists of tokens. The found synonym index entries are used for expanding the search for index documents to generate a search results list. The search results list is sorted based on a confidence score from the index documents and synonym matching strength from the expanded index documents obtained as synonyms to form a sorted search results list. Outputting the sorted search results list.

Still another embodiment of the invention provides a computer program product for providing search results comprising a computer usable medium having computer readable program code embodied therewith, the computer readable program code comprising: computer readable program code configured to receive a text search term from an interface device to search portions of a plurality of index documents and a plurality of synonym index entries. The computer readable program code is further configured to search the plurality of index documents to return index documents matching the text search term. The computer readable program code is further configured to analyze the text search term for classified text search terms in one or more sorted lists of tokens representing the text search term and associated synonyms. The computer readable program code is further configured to search the plurality of synonym index entries to find synonym index entries associated with the sorted lists of tokens. The computer readable program code is further configured to use the classification matches from the synonym index entries for expanding the index document search to generate a search results list including expanded indexed documents. The computer is further caused to sort the results list based on a confidence score from the index documents and the synonym matching strength to form a sorted search results list. The computer is further caused to output the sorted search results list.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates a user interface system returning search results based on received text and synonyms associated with the received words according to one embodiment of the invention;

FIG. 2 illustrates an example of multiple documents stored in a first repository having a regular index according to one embodiment of the invention;

FIG. 3 illustrates an example of multiple entries stored in a second repository having a synonym index according to one embodiment of the invention;

FIG. 4 illustrates an example of a token cache representation according to an embodiment of the invention;

FIG. 5A illustrates an example of input search text split into a list according to an embodiment of the invention;

FIG. 5B illustrates an example of the list illustrated in FIG. 5A split into a sorted list according to an embodiment of the invention;

FIG. 6 illustrates a client-server system returning search results based on received text and synonyms associated with the received words according to one embodiment of the invention;

FIG. 7 illustrates a block diagram of a search retrieval process according to one embodiment of the invention; and

FIG. 8 illustrates a distributed system according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification, as well as meanings understood by those skilled in the art and/or as defined in dictionaries, treatises, etc. The description may disclose several preferred embodiments for improved search retrieval, including associated synonym based search results, as well as operation and/or component parts thereof. While the following description will be described in terms of search retrieval systems and processes for clarity and placing the invention in context, it should be kept in mind that the teachings herein may have broad application to all types of systems, devices and applications.

Embodiments of the invention assist a user by broadening search terms when a user is not familiar with the terminology of a topic or classification. Additionally, during classification of subject matter for a hierarchical list of topics, synonyms are used with facet (a facet may comprise clear definitions and collectively exhaustive aspects, properties or characteristics of a class or specific subject) category labels, where the laborious and time consuming task of actually classifying items is reduced.

One embodiment of the invention provides a method and system for providing faceted browsing with free form text query interpretation based on text and associated synonyms. One implementation comprises an input module configured for receiving one or more text search terms. A search module is configured for searching index documents with the text search terms to return matched index documents, and for searching a plurality of synonym index entries to return classifications for synonym expansion for expanding the search for index documents. An analyzer module is configured for obtaining tokens for the text search term from the synonym index entries for determining one or more matched synonym index entries. The search module is further configured for obtaining assigned synonym matching strength information of the matched synonym index entries in a search results list, and sorting the search results list based on a confidence score from the index documents and the assigned synonym matching strength of the index documents from the synonym expansion to form a sorted search results list. An output module for presenting the sorted search result list on an interface module.

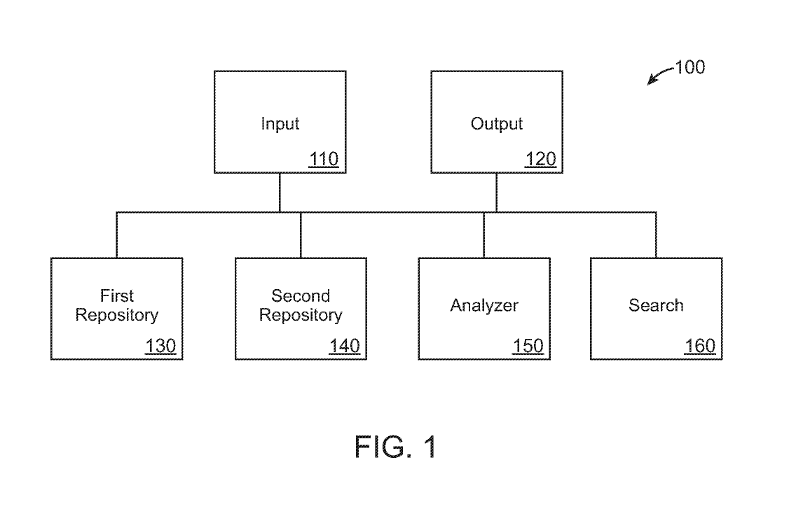

FIG. 1 illustrates a user interface system 100 according to one embodiment of the invention. In one embodiment of the invention, the user interface system 100 comprises an input module/device 110, an output module/device 120, a first (regular) index repository 130, a second (synonym) index repository 140, an analyzer module/device 150 and a search module/device 160. In one implementation of the invention, the first repository 130 and the second repository 140 may be combined into one repository, distributed in multiple separate or combined repositories, etc. The interface system 100 provides faceted browsing (i.e., browsing information to refine long lists of search results, along multiple dimensions/facets) with free form text query interpretation based on text and associated synonyms. In faceted browsing, each facet group becomes a navigation item. For example, if the subject matter selected to view is related to household appliances, facets may include washing machines, refrigerators, microwaves, etc. If a user chooses the facet of refrigerators, a navigational interface, such as a menu, would be displayed for further navigation. In the new navigational interface, an example may include brands, price, style of refrigerator (e.g., side-by-side, bottom freezer, top freezer, etc., with or without icemaker, etc.). A user may select refrigerators less than $500 dollars, and then from another resulting facet, may search for those with icemakers. This may repeat until the user narrows down their results.

In one embodiment of the invention, each element in the first index repository 130 is denoted as a document, and each item in the second index repository 140 is denoted as an entry. Each document in the first index repository 130 may represent a search result for a user query. Each such document comprises stored information/metadata such as text or encoded strings representing a result title, description, a list of text strings associated with the title and description, multiple classifications, etc.

In one example, the first index repository 130 and the second index repository 140 are implemented in one or more of the following types of machine-readable memories: semiconductor firmware memory, programmable memory, non-volatile memory, read only memory, electrically programmable memory, random access memory, flash memory, magnetic disk memory, and/or optical disk memory, memory device arrays, virtual memory space using a memory device, etc. Either additionally or alternatively, the first index repository 130 and the second index repository 140 may comprise other and/or later-developed types of computer-readable memory.

In one embodiment of the invention, the input module 110 is configured for receiving one or more search queries in the form of text search terms from a user, to search portions of index documents in the first index repository 130 and synonym index entries in the second index repository 140. The output module 120 is configured for receiving a result list at the conclusion of a search query. The text search terms may be entered into the input module 110 by using input devices, such as a keyboard, a selection via a pointing device (e.g., a mouse), voice commands converted into text, resistive digitizers (i.e., touch-screens), etc. In some embodiments, the results of a search are received via the output module 120 and may be displayed, such as on any type of display screen (e.g., cell phone, monitor, personal digital assistant (PDA), etc.).

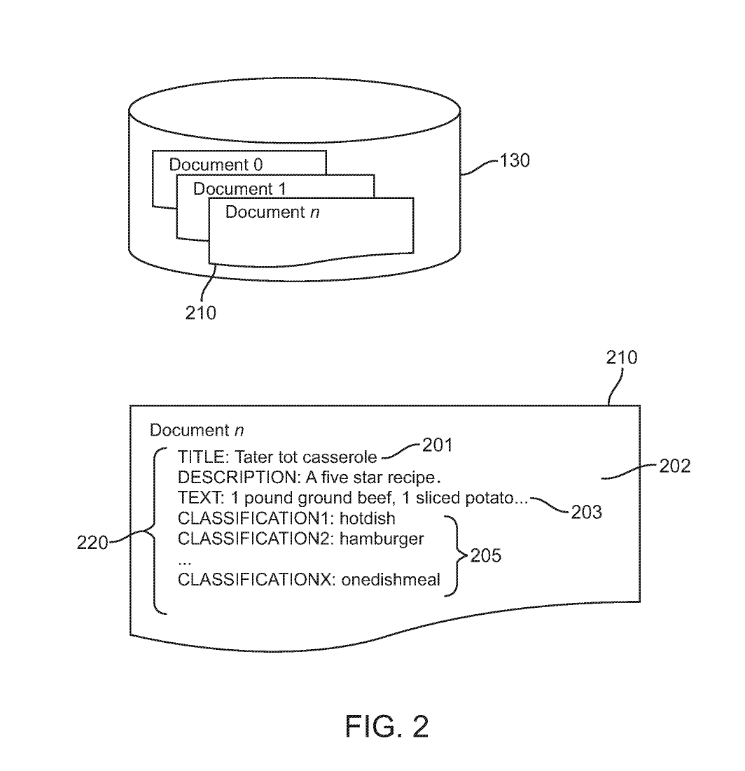

FIG. 2 illustrates an example of documents 210 stored in the first repository 130 having a regular index. For example, metadata 220 in the form of a document 210 contained in the repository 130 is used to return a result from a search query (e.g., how the result is classified). In one example, metadata 220 comprises a title of the document 201, a description of the document 202, text 203 and classification labels 205, if there is one. In one embodiment of the invention, the number of classification labels 205 is equal to or greater than zero for each metadata 220.

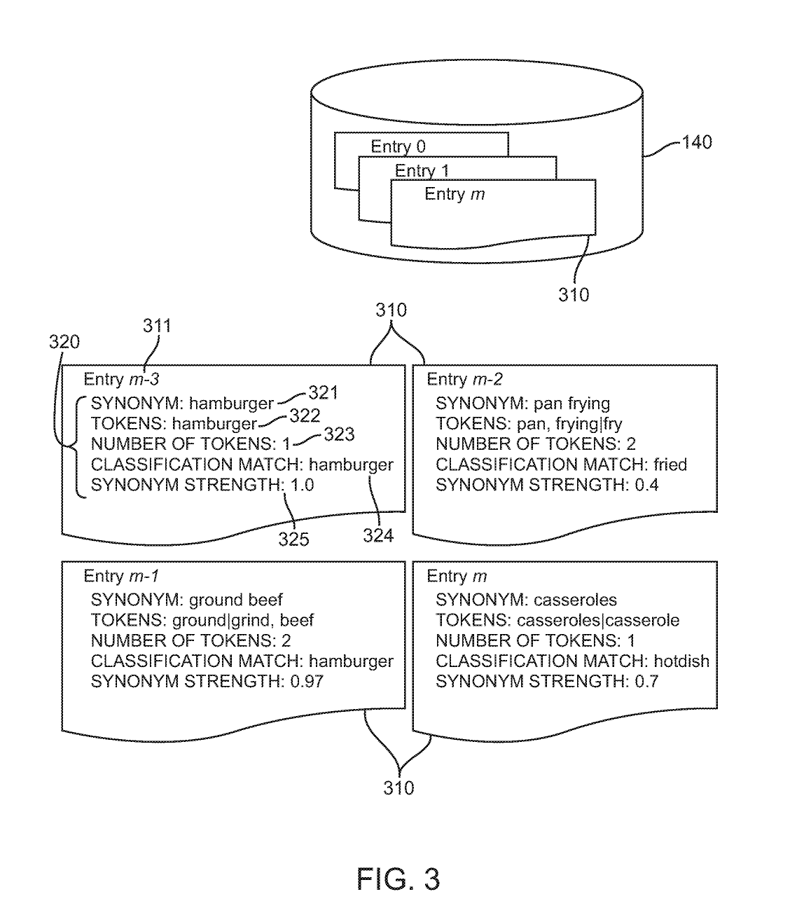

FIG. 3 illustrates an example of multiple synonym index entries 310 stored in the second repository 140 having a synonym index. Each document 310 in the second index repository 140 has a unique identifier 311 and contains metadata 320 that comprises: a synonym 321 of a classification label 205, tokens 322 that exist once the synonym is analyzed, number of tokens 323 in an analyzed synonym, a unique identifier 324 that indicates the actual classification item which will be used to expand the search of the index documents 205, and synonym strength 325 with respect to the actual classification item, etc. It should be noted that in some embodiments of the invention, the expansion of the search for index documents is accomplished by expanding the search terms before searching for index documents 205 is performed. In one or more embodiments of the invention, the expansion of the search for index documents is accomplished by expanding the search results after an initial search for index documents 205 is performed.

In one example, the synonym strength 325 is a number greater than 0, but less than or equal to 1, with 1 representing an exact match. In other examples, other schemes may be used for synonym strength 325, such as different ranges, etc. In one example, classification hierarchy labels are also added to the second index repository 140 to allow exact matches of the classification labels to be considered as well.

In one embodiment of the invention, the analyzer module 150 is configured to analyze search query text for classified text in one or more sorted inner and outer lists of tokens representing the text and associated synonyms. In one example, a token 322 comprises one or more words representing a synonym of a text word.

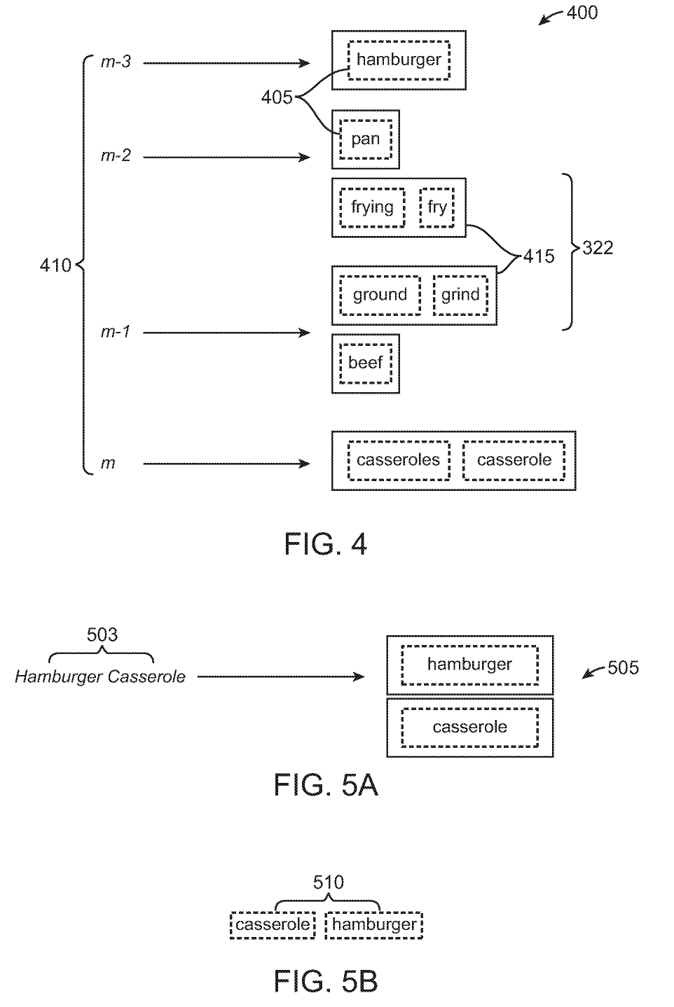

In one embodiment of the invention, instead of repeatedly querying the second index repository 140 to obtain classification matches 324 for documents in the first repository 210, the tokens 322 are added to an in-memory map where the key of the map represents the entry identification (ID) 311 and the value of the map is a list of a list of tokens 322. FIG. 4 illustrates an example of a token cache 400 representing an array of token lists including an inner list 405 (directed to the dashed lines) and an outer list 415 of tokens (directed to the outer solid lines). The elements of the outer list 415 represent tokens 322 that are distinct from one another, while the elements of the inner list 405 represent various language inflections of the tokens 322.

In one embodiment of the invention, search terms entered by a user are analyzed by the analyzer module 150 to obtain tokens 322 and split into an array of token lists similar to the token cache 400 illustrated in FIG. 4. In one example, the analyzer module 150 may use different techniques to obtain and split the list into token lists, such as look-up techniques, tree traversal techniques, database traversal techniques, text string manipulation techniques, etc.

FIG. 5A illustrates an example of entered search text 503 placed into a list 505. FIG. 5B illustrates the list 505 illustrated in FIG. 5A placed into a sorted array 510 of tokens. The sorted array 510 results from the analysis of the user entered search terms being split into separate tokens. Because classification labels 205 can nest inside each other, one embodiment of the invention uses the entire set of documents 310 in the second index repository 140 for identifying matches with the search text and then eliminates non-matches with the search text from the token cache 400, rather than simply query the second index repository 140 and return documents as in a basic search.

In one embodiment, the search module 160 searches through each entry 310 to determine if it is a match with the search text. To reduce the number of synonym index entries 310 that must be searched, in one example a range limited search is used, where the synonym index entries 310 considered must have a particular range for a number of tokens 322, such as a range between 0 and the number of outer lists returned, a predetermined fixed number, etc.

In one implementation of the invention, for each entry 310 still in consideration as being in a particular range of number of tokens 322, the tokens 322 are obtained for the document using a token cache, such as the token cache 400. In one embodiment of the invention, the token cache 400 assists in quickly determining if the tokens 322 in the analyzed user entered text match analyzed synonym tokens 322. The synonym tokens 322 are synonyms of the classified categories. In one or more embodiments of the invention, care is taken so that the inflected forms of the synonyms are accommodated, for example, a cook book may have a classification for fried food. In the examples shown, it is desired to include all the fried classified results if a user searches on ‘Pan fry’ or ‘Pan frying.’ In one embodiment of the invention, the structure of the token cache 400 is a list of lists. As discussed above, the inner lists 405 represent various language inflections of a word. For example, in entry m-2 311, the word frying has two language-inflected forms of frying and fry.

As discussed above, the token outer lists 415 separate the distinct lists. For example, ‘pan’ is one outer list 415 that has no inflected forms (so only ‘pan’ is in the inner list). ‘Frying’ is an outer list 415 that has two inflected forms, ‘frying’ and ‘fry’ (which are the inner lists 405). In one embodiment of the invention, a cache memory device is used for assisting in processing speed.

If at least one token from each outer list 415 is a match, for each entry that has a token match, the classification match value 324 of the entry 310 is saved in an aggregated list and the synonym strength value 325 of the entry 310 is saved in a separate, but parallel aggregated list. In this case, all the matching tokens 322 are saved in an aggregated list, which may be stored in a memory device.

In one embodiment of the invention, the matched token list in the token cache 400 is sorted and used to ensure that at least one token 322 from each of the outer lists of the sorted array of user tokens 510 is consumed. If there is an unconsumed token 510, the aggregated lists are cleared, ensuring that as a user refines his/her search query, changes to the result list are apparent.

For example, a user may enter the search query “chicken” and receive five hundred result documents back, four hundred of which are classified with chicken and one hundred additional results that contain the word chicken in the text, title, or description of the document. If the user refines the query to “chicken foo”, then zero results will be returned. The “foo” token was not consumed, resulting in the classification match of chicken being cleared to prevent the four hundred classified results from being shown.

In one embodiment of the invention, besides application of synonym matching, additional matching may be used, such as classification type based on a type of category. For example if a user performs a text search for “fried food,” multiple category types, such as fried seafood, fried vegetables, fried meats, etc. (which can also be broken down into further category types) may be matched for improving a query.

In one embodiment of the invention, the classification matches are intersected if more than one classification was found, and the strength of the synonym or type match is used to effect the ranking weight or confidence score of the classification. In one example, a user's query matches more than one classification. In this example, a user performs a text search for ‘Installing AIX.’ In this example, both a classification of ‘Install’ and a classification of ‘AIX’ is matched. In this embodiment of the invention, the documents that are classified with both ‘Install’ and ‘AIX’ are considered. The documents that only match one of the categories are discarded since these documents would not be relevant to the complete search query. In other embodiments of the invention, the confidence score can be based on feedback from other users, surveys, probability, etc.

In one implementation of the invention, the results of the intersection are included and sorted with the results from the normal text search results obtained from only the first index repository 130 documents 210. In one example, by operation of the search module, document n 210 will be returned as a result of a search on “hamburger casserole” even though the word “hamburger” never appeared in the text, title, or description. Therefore, the user interface system 100 provides faceted browsing in combination with free text query including elements of classification related as at least one synonym.

In one embodiment of the invention, the index documents 210 and synonym index entries 310 are initially provided by a publisher, such as a system administrator, a company website, organization, university, individual, etc. In one example, an author classifies the documents for faceted browsing, and also defines the synonyms for the classification labels. This provides the author a level of control over how the synonyms effect the results that are returned. A unification between the user text search and the classification labels 205, also provides the benefit of moving from the lexical space (words) into the semantic space (meaning) as defined by the author. In another example, the index documents 210 and synonym index entries 310 may be learned over time based on search queries and positive/negative feedback as to the accuracy of the returned results.

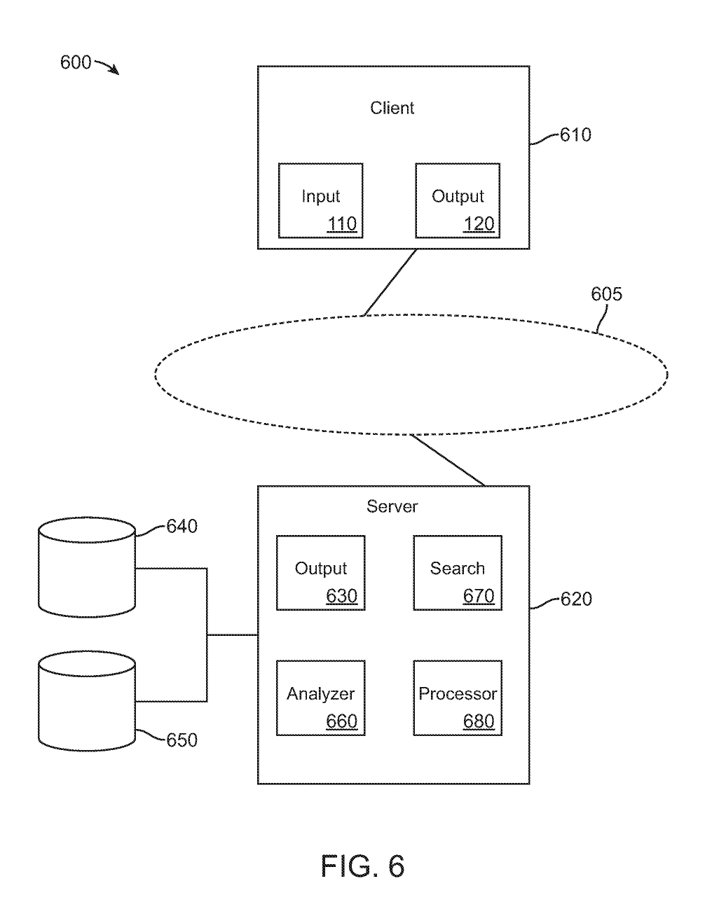

FIG. 6 illustrates an example client-server system 600, implementing an embodiment of the invention. The system 600 comprises a client device 610 including an input module 110 and an output module 120 with similar functionality as with interface system 100. The system 600 further includes a server device 620 comprising an output module 630, an analyzer module 660, a search module 670 and a processor 680. A first index repository 640 and second index repository 650 are coupled to the server 620. In one embodiment of the invention, the first index repository 640 is similar in functionality as with first index repository 130, and the second index repository 650 is similar in functionality as with the second index repository 140.

The client device 610 communicates with the server device 620 via a wired or wireless connection 605. The connection 605 may be a local area network (LAN), wireless LAN (WLAN), Internet, local network, home network, private network, etc.

In one example, the first index repository 640 and the second index repository 650 are implemented in one or more of the following types of machine-readable memories: semiconductor firmware memory, programmable memory, non-volatile memory, read only memory, electrically programmable memory, random access memory, flash memory, magnetic disk memory, and/or optical disk memory, memory device arrays, virtual memory space using a memory device, etc. Either additionally or alternatively, the first index repository 640 and the second index repository 650 may comprise other and/or later-developed types of computer-readable memory.

The system 600 provides faceted browsing in combination with free text query including elements of classification related as at least one synonym similarly with respect to interface system 100. A browser is used by the client 610 to communicate over the connection 605 with the server 620.

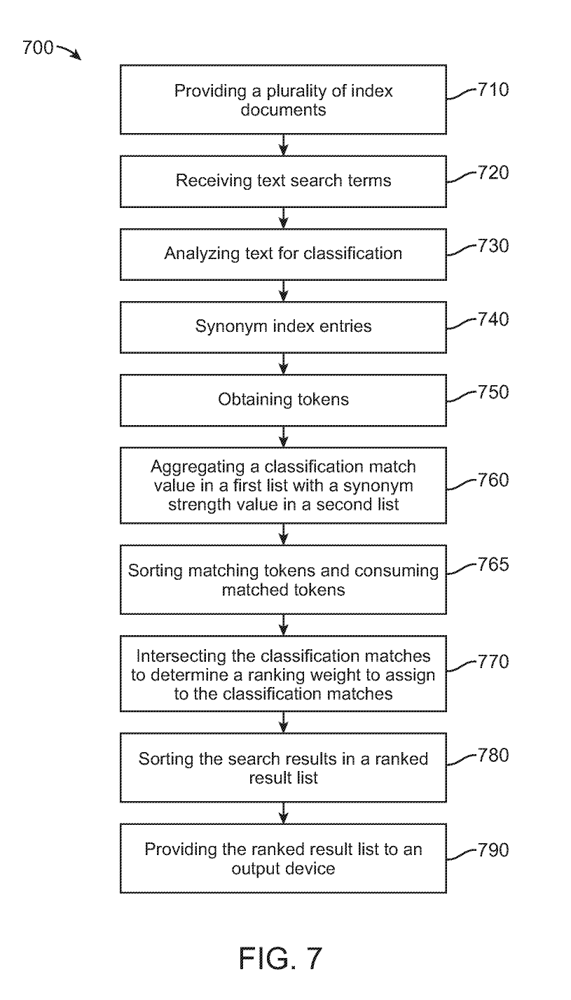

FIG. 7 illustrates a block diagram of a process 700 for providing faceted browsing in combination with free text query including elements of classification related as at least one synonym, implemented by the system 600. Process 700 includes block 710 where regular index documents 210 and synonym index entries 310 are provided. Text search query terms are received in block 720. The received search terms may be entered through many types of interfaces, such as a keyboard, a selection via a pointing device (e.g., a mouse), voice commands converted into text, resistive digitizers (i.e., touch-screens), etc. Process 700 continues with block 730, where the entered text query is analyzed for classification.

Block 730 performs a similar function as the analyzer module 150 including analyzing the query text into one or more sorted inner and outer lists of tokens 322 representing the text and associated synonyms. For example, user entered search terms are analyzed in block 730 to obtain tokens 322, where the tokens 322 are split into an array of token lists similar to the token cache 400 illustrated in FIG. 4. In one example, block 730 may use different processing to obtain and split the list into token lists, such as look-up processing, tree traversal processing, database lookup processing, text string manipulation processing, etc.

Process 700 continues with block 740 where the synonym index entries 310 are searched to find entries associated with a range of tokens less than or equal to the number of lists of tokens according to one embodiment of the invention. In one example, block 740 searches the synonym index entries 310 to find entries associated with a range of tokens 322 less than or equal to the number of lists of tokens 322, and a sorted array 510 of the tokens 505 results from splitting of the user's entered search terms 503 is obtained.

The block 740 may further search through each entry 310 to determine if it is a match with the analyzed search text, and uses a range limited search where any documents 310 used in consideration must have a particular range number of tokens 322, such as a range between 0 and the number of outer lists returned, a predetermined fixed number, etc. In block 750 tokens are obtained for each of the documents found in block 740.

Process 700 continues with block 760 where if at least one token 322 from each of the outer lists matches a token 322 from the sorted list, such as sorted array of tokens 510, then the classification match value 324 of the document 310 is saved in an aggregated list. Further, the synonym strength value 325 of the document 310 is saved in a separate, but parallel aggregated list. In one example, all the matching tokens 322 are saved in an aggregated list in a memory device or space.

In block 765 the matching tokens 322 are sorted and placed in the token results list 510 and used to ensure that at least one token 322 from each of the outer lists is consumed by the analyzer module 660 to form the sorted array of tokens 510 as a result list. If there is an outer list with unconsumed tokens 322, the aggregated lists are cleared to ensure that as a user refines their search query, changes to the result list are apparent. For example, a user may enter the search query “lobster” and receive five hundred results back, four hundred of which are classified with lobster and one hundred additional results that contain the word lobster in the text, title, or description of the document. In one embodiment of the invention, along with the search for “lobster,” associated synonyms and/or types of lobster (e.g., Maine lobster, Australian lobster, size, whole or tail, baked lobster, broiled lobster, etc.) may additionally be used in a query to assist a user that may not be familiar with the subject of lobsters. If the user refines their query to “lobster foo” then zero results will be returned. The “foo” token was not consumed so the classification match of lobster was cleared to prevent the four hundred classified results from being shown.

In block 770 the classification matches are intersected, and the strength of the synonym match is used to effect the ranking weight of the classification similarly as discussed above regarding system 100 and system 600.

In block 780, the classification matches that results from the intersection are used to search the classifications 205 of the first repository 130 and these results are expanded using synonym index entries 310 as opposed to typical text search results obtained from only the first index repository 130 documents 210. In one embodiment of the invention, the search results are also sorted in a ranked order. This process 700 provides processing for faceted browsing in combination with free text query including elements of classification related as at least one synonym. As such, in block 790, a document n 210 is provided (e.g., by an output module 120) as a result of a search on, for example, “hamburger casserole” even though the word “hamburger” never appeared in the text, title, or description.

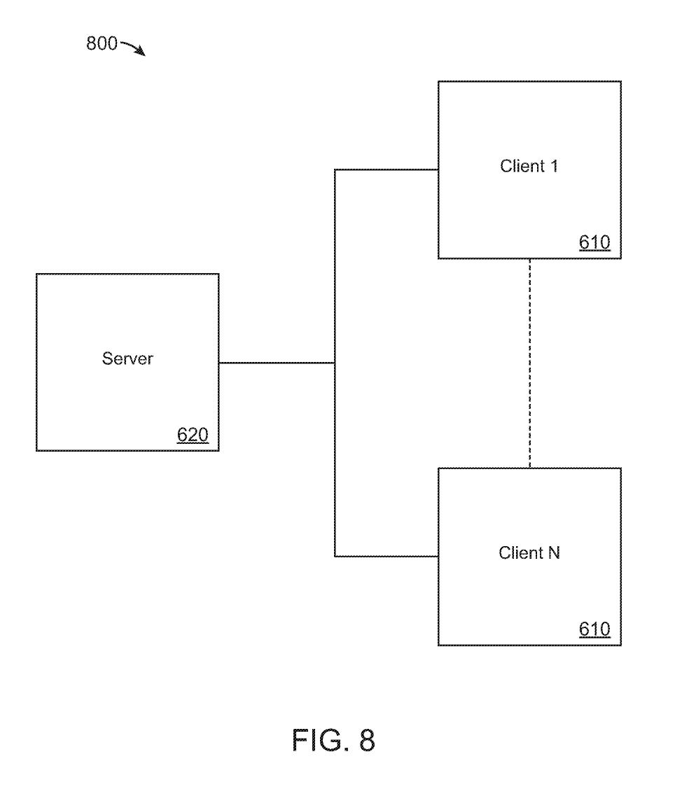

FIG. 8 shows a block diagram of example architecture of an embodiment of a distributed search system 800 according to an embodiment of the invention. In this embodiment of the invention, the distributed system 800 includes clients 1 610 through client N 610 that may be distributed, in any combination in a network (e.g., a local area network (LAN), wireless LAN (WLAN), Internet, local network, home network, private network, etc.), and connect to a server 620 via a wire or wireless network. When the distributed search system 800 uses the Internet, the network represents a worldwide collection of networks and gateways that use the Transmission Control Protocol/Internet Protocol (TCP/IP) suite of protocols to communicate with one another. Included as central to the Internet is a backbone of high-speed data communication lines between major nodes or host computers, comprising a multitude (e.g., thousands, tens of thousands, etc.) of commercial, governmental, educational and other computer systems that route data and messages.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart illustrated in FIG. 7 and block diagrams in FIGS. 1, 6 and 8 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

I/O devices (including but not limited to keyboards, displays, pointing devices, resistive digitizers (i.e., touch screens), etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters. In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An interface system comprising:
an input module configured for receiving a text search term;
a search module configured for searching a plurality of index documents with the text search term to return matched index documents, and for searching a plurality of synonym index entries to return classifications for synonym expansion for expanding the search for index documents;
an analyzer module configured for:
obtaining tokens for the text search term from the synonym index entries for determining one or more matched synonym index entries;
the search module further configured for:
obtaining assigned synonym matching strength information of the matched synonym index entries in a search results list;
sorting the search results list based on a confidence score from the index documents and the assigned synonym matching strength of the index documents from the synonym expansion to form a sorted search results list; and
an output module for presenting the sorted search result list on an interface module.

2. The interface system of claim 1, wherein the interface system provides faceted browsing in combination with free text query including elements of classification related as at least one synonym.

3. The interface system of claim 1, further comprising:
a first repository including the plurality of index documents; and
a second repository including the plurality of synonym index entries.

4. The interface system of claim 2, wherein the plurality of index documents and the plurality of synonym index entries are one of initially provided by a publisher and learned based on search queries and feedback.

5. The interface system of claim 1, wherein the information from the returned matched index documents includes equal to or greater than zero classification labels, and each synonym index entry including one or more tokens representing a synonym.

6. A system comprising:
a server device coupled to
a first repository including a plurality of index documents;
a second repository including a plurality of synonym index entries;
an analyzer module configured to analyze received text for classified text in a list of tokens representing the received text and associated synonyms for the received text; and
a search module configured for searching the plurality of synonym index entries to find synonym index entries associated within a determined range of tokens, obtaining tokens for each found synonym index entry; aggregating the obtained tokens in a list of tokens, expanding a search for index documents using the synonym index entries, sorting a search results list based on a confidence score of the index documents and assigned synonym strength obtained from the found synonym index entries and providing the sorted search results list as output.

7. The system of claim 6, further comprising:
a client device coupled with
an input module configured for receiving a search term to search portions of the plurality of index documents and the plurality of synonym index entries; and an output module configured for presenting the sorted search results list from the server device.

8. The system of claim 6, wherein the plurality of index documents and synonym index entries are initially provided by a publisher.

9. The system of claim 8, wherein the plurality of index documents and synonym index entries are learned based on search queries and feedback.

10. The system of claim 6, wherein each index document includes equal to or greater than zero classification labels, and each synonym index entry includes one or more tokens each representing a synonym.

11. A method comprising:
providing a plurality of index documents and a plurality of related synonym index entries;
receiving a text search term from an interface device to search portions of the plurality of index documents and the plurality of synonym index entries;
searching the plurality of index documents to return index documents matching the text search term;
analyzing the text search term for classified text search terms in one or more sorted lists of tokens representing the text search term and associated synonyms;
searching the plurality of synonym index entries to find synonym index entries associated with the sorted lists of tokens;
expanding a search for index documents based on found synonym index entries to generate a search results list;
sorting the search results list based on a confidence score from the index documents and synonym matching strength from the expanded index documents obtained as synonyms to form a sorted search results list; and
outputting the sorted search results list.

12. The method of claim 11, wherein faceted browsing in combination with free text query including elements of classification related as at least one synonym is provided.

13. The method of claim 11, wherein the plurality of index documents and synonym index entries are initially provided by a publisher.

14. The method of claim 13, wherein the plurality of index documents and synonym index entries are populated based on search queries and feedback.

15. The method of claim 11, wherein the lists of tokens comprises an inner list of tokens representing language inflections of the tokens and an outer list of tokens representing distinct tokens.

16. A computer program product providing search results comprising:
a computer usable medium having computer readable program code embodied therewith, the computer readable program code comprising:
computer readable program code configured to
receive a text search term from an interface device to search portions of a plurality of index documents and a plurality of synonym index entries;
search the plurality of index documents to return index documents matching the text search terms;
analyze the text search terms for classified text search terms in one or more sorted lists of tokens representing the text search term and associated synonyms;
search the plurality of synonym index entries to find synonym index entries associated with the sorted lists of tokens;
expand the search for index documents based on found synonym index entries to generate a search results list including expanded indexed documents;
sort the search results list based on a confidence score of the indexed documents and synonym matching strength of the expanded indexed documents obtained as synonyms to form a sorted search results list; and
output the sorted search results list.

17. The computer program product of claim 16, wherein the computer is further caused to provide faceted browsing in combination with free text query including elements of classification related as at least one synonym.

18. The computer program product of claim 16, wherein the plurality of index documents and synonym index entries are initially provided by a publisher.

19. The computer program product of claim 18, wherein the plurality of index documents and synonym index entries are populated based on search queries and feedback.

20. The computer program product of claim 16, wherein the lists of tokens comprises an inner list of tokens representing language inflections of the tokens and an outer list of tokens representing distinct tokens.
